(19) United States
(12) Patent Application Publication
(10) Pub. No.: US 2026/0050465 A1
(43) Pub. Date: Feb. 19, 2026

(54) METHOD AND APPARATUS FOR CONTROLLING VIRTUAL MACHINE STARTING BASED ON CLONED BLOCK DEVICE, AND ELECTRONIC DEVICE

(71) Applicant: Beijing Volcano Engine Technology Co., Ltd., Beijing (CN)

(72) Inventors: Zhi Shu, Beijing (CN); Wentao Fan, Beijing (CN); Pengwei Zhao, Beijing (CN); Xingjian Ye, Beijing (CN)

(21) Appl. No.: 19/259,671

(22) Filed: Jul. 3, 2025

(30) Foreign Application Priority Data
Aug. 14, 2024 (CN) 202411117910.8

(51) Int. Cl. G06F 9/455

(52) U.S. Cl. CPC G06F 9/45558; G06F 2009/45562

(57) ABSTRACT

Embodiments of the present disclosure provide a method for controlling virtual machine starting based on a cloned block device, and an apparatus and an electronic device. The method includes: receiving a lazy load request sent by a virtual machine to a block device of elastic block storage, acquiring target snapshot data, and sending a snapshot download request to an image center to download at least two snapshot copies; connecting each of the block devices to a corresponding snapshot copy to obtain log files corresponding to the at least two snapshot copies respectively; and forming a cloned block device by loading, through the block device, a log file corresponding to the snapshot copy to, and starting the virtual machine based on the cloned block device.

### CROSS-REFERENCE TO RELATED APPLICATION

This application claims priority to Chinese Application No. 202411117910.8 filed on Aug. 14, 2024, the disclosure of which is incorporated herein by reference in its entirety.

### FIELD

Embodiments of the present disclosure relate to the technical field of cloud computing and, in particular, to a method and apparatus for controlling virtual machine starting based on a cloned block device, and an electronic device.

### BACKGROUND

At present, there are a large number of elastic requirements in cloud computing services, such as elastic computing service (ECS), etc., and the system can quickly start a large number of virtual machines in a batch cloning manner according to the requirements of users. In this process, in order to realize the quick starting of the virtual machine, the system will use the lazy load technology to synchronously download some block data in the starting process of the virtual machine and load the block data into the corresponding block device while downloading the image data, so as to realize the quick starting of the virtual machine. After that, and after the image data is downloaded, the data resource is loaded into the block device through the image data to realize the complete starting of the virtual machine.

### SUMMARY

Embodiments of the present disclosure provide a method and apparatus for controlling virtual machine starting based on a cloned block device, and an electronic device.

In a first aspect, an embodiment of the present disclosure provides a method for controlling virtual machine starting based on a cloned block device, including:
receiving a lazy load request sent by a virtual machine to a block device of elastic block storage, acquiring target snapshot data, and sending a snapshot download request to an image center to download at least two snapshot copies, where the block device is used to store a data resource required for starting the virtual machine, a snapshot copy is image data of the data resource required for starting the virtual machine, and the target snapshot data is a data resource required for running a target function of the virtual machine; connecting each block device to a corresponding snapshot copy to obtain the log files corresponding to the at least two snapshot copies respectively; and forming a cloned block device by loading, through the block device, a log file corresponding to the snapshot copy, and starting the virtual machine based on the cloned block device.

In a second aspect, an embodiment of the present disclosure provides an apparatus for controlling virtual machine starting based on a cloned block device, including:
a processing module, configured to receive a lazy load request sent by a virtual machine to a block device of elastic block storage, acquire target snapshot data, and send a snapshot download request to an image center to download at least two snapshot copies, where the block device is used to store a data resource required for starting the virtual machine, a snapshot copy is image data of the data resource required for starting the virtual machine, and the target snapshot data is a data resource required for running a target function of the virtual machine;
a storage module, configured to connect each block device to a corresponding snapshot copy to obtain log files corresponding to the at least two snapshot copies respectively; and
a loading module, configured to form a cloned block device by loading, through the block device, a log file corresponding to the snapshot copy, and start the virtual machine based on the cloned block device.

In a third aspect, an embodiment of the present disclosure provides an electronic device, including: a processor and a memory;
where the memory stores computer-executable instructions; and
the processor executes the computer-executable instructions stored in the memory, to enable the at least one processor to execute the method for controlling virtual machine starting based on a cloned block device according to the above first aspect and various possible designs of the first aspect.

In a fourth aspect, an embodiment of the present disclosure provides a computer-readable storage medium, where computer-executable instructions are stored in the computer-readable storage medium, and when the computer-executable instructions are executed by a processor, the method for controlling virtual machine starting based on a cloned block device according to the above first aspect and various possible designs of the first aspect is implemented.

In a fifth aspect, an embodiment of the present disclosure provides a computer program product, including a computer program, where when the computer program is executed by a processor, the method for controlling virtual machine starting based on a cloned block device according to the above first aspect and various possible designs of the first aspect is implemented.

### BRIEF DESCRIPTION OF THE DRAWINGS

In order to illustrate the technical solutions in the embodiments of the present disclosure or in the prior art more clearly, the drawings needed in describing the embodiments or the prior art will be briefly introduced below. Obviously, the drawings in the following description are some embodiments of the present disclosure, and other drawings can be obtained by those skilled in the art according to these drawings without creative efforts.

FIG. 1 is a diagram of an application scenario of a method for controlling virtual machine starting based on a cloned block device according to an embodiment of the present disclosure;

FIG. 2 is schematic flowchart 1 of a method for controlling virtual machine starting based on a cloned block device according to an embodiment of the present disclosure;

FIG. 3 is a flowchart of a specific implementation of step S102 in the embodiment shown in FIG. 2;

FIG. 4 is a schematic diagram of a process of connecting a block device to a plurality of snapshot copies according to an embodiment of the present disclosure;

FIG. 5 is schematic flowchart 2 of a method for controlling virtual machine starting based on a cloned block device according to an embodiment of the present disclosure;

FIG. 6 is a flowchart of a specific implementation of step S204 in the embodiment shown in FIG. 5;

FIG. 7 is a flowchart of a specific implementation of step S2042 in the embodiment shown in FIG. 6;

FIG. 8 is a flowchart of a specific implementation of step S208 in the embodiment shown in FIG. 5;

FIG. 9 is a block diagram of a structure of an apparatus for controlling virtual machine starting based on a cloned block device according to an embodiment of the present disclosure;

FIG. 10 is a schematic diagram of a structure of an electronic device according to an embodiment of the present disclosure; and

FIG. 11 is a schematic diagram of a hardware structure of an electronic device according to an embodiment of the present disclosure.

### DETAILED DESCRIPTION OF EMBODIMENTS

In order to make the purpose, technical solutions and advantages of the embodiments of the present disclosure clearer, the technical solutions in the embodiments of the present disclosure will be described clearly and completely below with reference to the drawings in the embodiments of the present disclosure. Obviously, the described embodiments are only a part of the embodiments of the present disclosure, but not all of them. Based on the embodiments in the present disclosure, all other embodiments obtained by those skilled in the art without creative efforts shall fall within the protection scope of the present disclosure.

It should be noted that the user information (including but not limited to user device information, user personal information, etc.) and data (including but not limited to data for analysis, stored data, displayed data, etc.) involved in the present disclosure are information and data authorized by users or fully authorized by parties, and the collection, use and processing of relevant data need to comply with relevant laws, regulations and standards of relevant countries and regions, and corresponding operation entrances are provided for users to choose authorization or refusal.

Firstly, existing technical terms in the art are introduced.

Virtual machine (VM): refers to a complete computer system with complete hardware system functions simulated by software and running in a completely isolated environment, which is provided by a cloud service provider to cloud tenants.

Elastic computing service (ECS): a service provided by a cloud service, which is used to implement dynamic expansion and reduction of computing resources (such as memory, bandwidth, infrastructure, etc.).

Elastic block storage (EBS): a service provided by a cloud service for implementing dynamic expansion and reduction of storage resources.

Node: a service machine in ECS and EBS.

Cluster: a management unit composed of a plurality of nodes in ECS and EBS.

Availability zone (AZ): a management unit of independent power supply and network resources for users in cloud computing, including a plurality of clusters.

Region: a management unit of a single region in cloud computing, including a plurality of availability zones.

Block device: a virtual block device provided by EBS, including an empty disk and a snapshot cloned block device.

Device segment: the block device is divided into segments according to a fixed size, such as 32 GB.

Snapshot: a value-added service of EBS, which stores instantaneous data snapshots of a block device on an object storage.

Snapshot copy: a storage form of snapshot data after being downloaded to an EBS cluster.

Snapshot segment: the snapshot copy is divided into segments according to a fixed size, such as 4 GB.

Strip: Strip includes strip size (e.g., 32 KB), and number of strips (e.g., 64).

Image: a single snapshot or a group of snapshots used to start a VM, and data is stored in a snapshot format.

Image center: a module responsible for managing images in ECS.

Batch cloning: creating block devices in batches by one image, and running virtual machine instances in batches based on the block devices.

Lazy load: in the process of creating and starting a virtual machine by an image, the virtual machine can be directly started without waiting for the image data to be loaded into the block device.

In the prior art, in the process of loading the data resource through the image data after the image data is downloaded, the block device has a problem that a read hotspot is easily formed, which causes pressure on the storage cluster and reduces the performance of the block device.

In the method and apparatus for controlling virtual machine starting based on a cloned block device, and the electronic device provided by the embodiment, the lazy load request sent by the virtual machine to the block device of elastic block storage is received, the target snapshot data is acquired, and the snapshot download request is sent to the image center to download at least two snapshot copies, where the block device is used to store the data resource required for starting the virtual machine, the snapshot copy is the image data of the data resource required for starting the virtual machine, and the target snapshot data is the data resource required for running the target function of the virtual machine; each block device is connected to a corresponding snapshot copy to obtain log files corresponding to the at least two snapshot copies respectively; and the log file corresponding to the snapshot copy is loaded through the block device to form the cloned block device, and the virtual machine is started based on the cloned block device. By downloading a plurality of snapshot copies from the image center during lazy loading, log files corresponding to a plurality of groups of snapshot copies are formed in the file storage system, so that the block device can obtain the required data resources from the plurality of groups of log files respectively to form the cloned block device, thereby avoiding the problem of read hotspot formed in the block device and improving the performance of the block device.

The application scenario of the embodiments of the present disclosure is explained below.

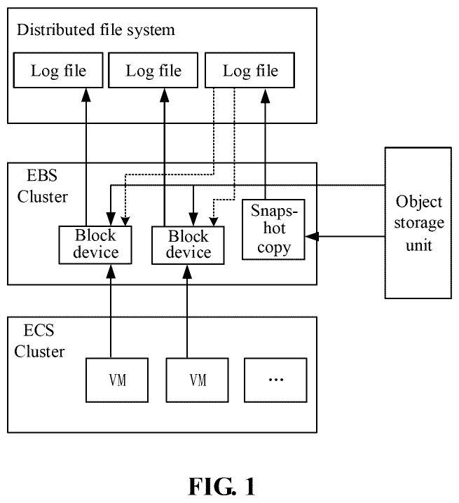

FIG. 1 is a diagram of an application scenario of a method for controlling virtual machine starting based on a cloned block device according to an embodiment of the present disclosure. The method for controlling virtual machine starting based on a cloned block device provided by the embodiments of the present disclosure can be applied to the application scenario of batch cloning to start a virtual machine. The execution body of this embodiment may be an elastic computing service or a physical machine and a server that provide the elastic computing service, and an electronic device with similar functions.

In some embodiments, the physical machine, the server, and other devices may implement the method for controlling virtual machine starting based on a cloned block device provided by the embodiments of the present application by running various computer-executable instructions or computer programs. For example, the computer-executable instructions may be program-level commands, machine instructions, or software instructions. The computer program may be a native program or a software module in the operating system; it may be a local application, that is, a program that needs to be installed in the operating system to run, or it may be a program that runs based on a browser environment. To sum up, the above computer-executable instructions may be instructions in any form, and the above computer program may be an application, a module, or a plugin in any form, and a specific implementation form may be configured according to requirements. Further, in some embodiments, the physical machine and the server may be independent physical servers, or a server cluster or a distributed system composed of a plurality of physical servers, or a cloud server that provides basic cloud computing services such as cloud services, cloud storage, cloud communication, cloud database, cloud computing, cloud functions, network services, middleware services, domain name services, security services, content delivery network (CDN), and big data and artificial intelligence platforms.

Referring to FIG. 1, in the application scenario of batch cloning a virtual machine, the lazy load technology is used to quickly clone a block device and start the virtual machine. Specifically, after a VM in an ECS cluster sends a lazy load request to a block device in an EBS cluster, on the one hand, the block device in the EBS cluster sends a data read request to an object storage unit to obtain corresponding block data and write the block data into the block device; on the other hand, the block device in the EBS cluster sends a request from an image center (the object storage unit) to download a snapshot copy. After the snapshot copy is downloaded, data sharing of the snapshot copy is realized by generating a Log file in a distributed file system, and the block device sends a file read request for the log file of the snapshot copy to the distributed file system, so as to write the log file into the block device, and finally realize the cloning of the block device and complete the starting process of the virtual machine.

In the prior art, in the scenario of batch cloning of block devices, since the snapshot copies will be shared with a large number of block devices at the same time after the downloading of the snapshot copies is completed, when these block devices initiate data read requests at the same time, the log data corresponding to the snapshot copies is likely to form a read hotspot, which causes pressure on the storage cluster and reduces the performance of the block devices.

The embodiments of the present disclosure provide a method for controlling virtual machine starting based on a cloned block device to solve the above problem.

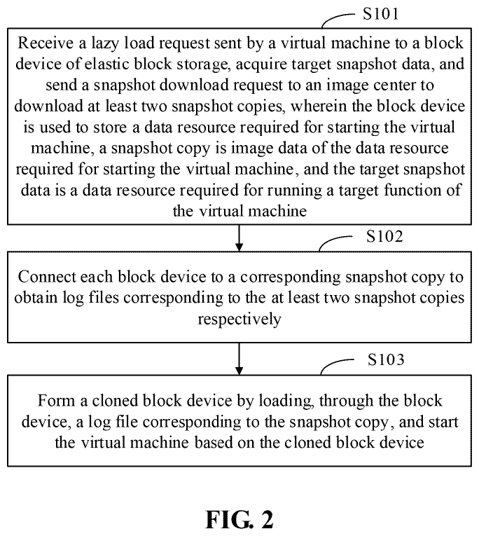

Referring to FIG. 2, FIG. 2 is schematic flowchart 1 of a method for controlling virtual machine starting based on a cloned block device according to an embodiment of the present disclosure. The method of this embodiment can be applied to a server, and the method for controlling virtual machine starting based on a cloned block device includes the following steps.

Step S101: A lazy load request sent by a virtual machine to a block device of elastic block storage is received, target snapshot data is acquired, and a snapshot download request to an image center to download at least two snapshot copies is sent, where the block device is used to store a data resource required for starting the virtual machine, a snapshot copy is image data of the data resource required for starting the virtual machine, and the target snapshot data is a data resource required for running a target function of the virtual machine; and

Step S102: Each block device is connected to a corresponding snapshot copy to obtain log files corresponding to the at least two snapshot copies respectively.

Step S103: A cloned block device is formed by loading, through the cloud disk, the log file corresponding to the snapshot copy, and the virtual machine is started based on the cloned block device.

Exemplarily, referring to the schematic diagram of the application scenario shown in FIG. 1, the block device is a functional unit for storing a data resource required for starting the virtual machine, where the data resource includes, for example, data such as an operating system, an application, and a configuration file required for running the virtual machine. The block device is located in the elastic block storage, and can be added or deleted elastically as required. When the virtual machine in the elastic computing service cluster starts, the corresponding resource data needs to be loaded into the block device, so a data loading request will be sent to the block device located in the elastic block storage to instruct the block device to load the resource data. In the scenario where the virtual machine is started based on the lazy load technology, the virtual machine will send a lazy load request to the block device located in the elastic block storage, and after receiving the lazy load request, the block device, on the one hand, will obtain corresponding block data required for running the target function of the virtual machine, that is, the target snapshot data, from an external object storage unit according to the current starting state and stage of the virtual machine. A specific implementation is, for example, sending a data read request for the target snapshot data to the object storage unit, receiving the target snapshot data returned by the object storage unit, and writing the target snapshot data into the block device at the same time, so as to start the target function of the virtual machine based on the target snapshot data in the block device. On the other hand, the block device will send a snapshot download request to the image center to download at least two snapshot copies. The snapshot copy is a snapshot data format, which is image data of the data resource required for starting the virtual machine, and the snapshot copy is a necessary resource required for cloning the block device, and a specific implementation thereof is the prior art and will not be repeated here.

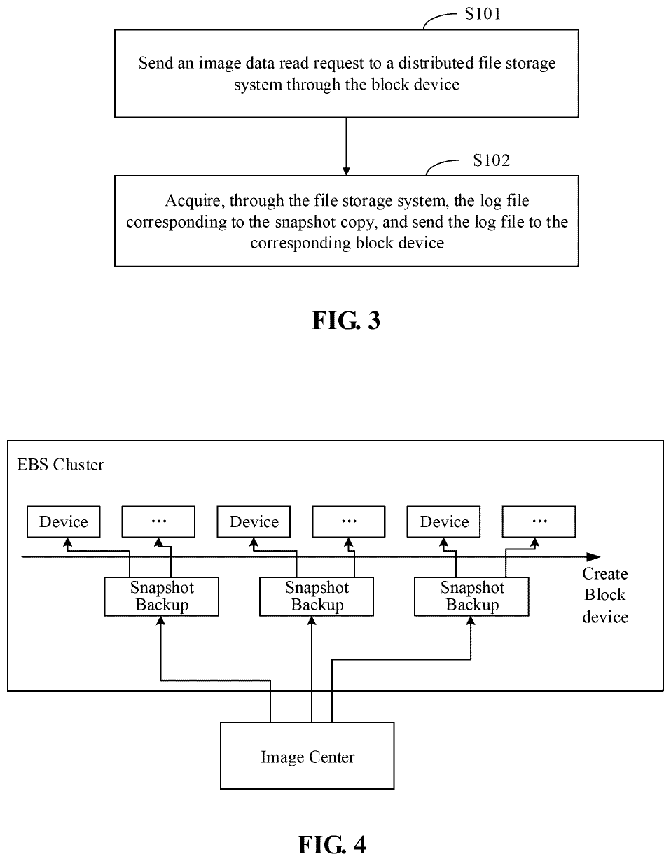

It should be noted that the snapshot download request sent by the block device to the image center in the step of this embodiment will download at least two snapshot copies from the image center. At the same time, each block device is connected to the corresponding snapshot copy to obtain the log file corresponding to the snapshot copy. The log file, that is, another data storage format of the snapshot copy, is stored in the distributed file storage system, and then the log clause is distributed through the file storage system, thereby realizing the sharing of the snapshot copy. In a possible implementation, as shown in FIG. 3, the specific implementation of step S102 includes the following steps.

Step S1021: An image data read request to a distributed file storage system through the block device is sent.

Step S1022: The log file corresponding to the snapshot copy is acquired through the file storage system, and the log file to the corresponding block device is sent.

Exemplarily, the file storage system may be a distributed file storage server, which is arranged inside or outside the device as the execution body of this embodiment. After the image data read request is sent to the file storage system through the block device, the file storage system retrieves the corresponding snapshot copy, and returns the snapshot copy to the corresponding block device based on the data transmission policy of the distributed system, so that the block device obtains the log file of the connected snapshot copy.

Thereafter, the block device loads the log file to form the cloned block device. The cloned block device is a virtual block device formed by loading the data resource corresponding to the snapshot copy, and the content carried by the cloned block device is a “clone” of the data provided by the snapshot service, thereby realizing the purpose of cloning and starting the virtual machine.

It can be known from the above introduction that after receiving the lazy load request, the block device may be divided into two execution stages from the focus of driving the virtual machine to start. The first execution stage is before the downloading of the snapshot copy is completed, which is a process of driving the operation and starting of some functions of the virtual machine by obtaining the target snapshot data from the object storage unit and writing the target snapshot data into the block device, that is, the lazy load stage. The second execution stage is after the downloading of the snapshot copy is completed, and the block device sends a data request to the file storage system to obtain the log file corresponding to the snapshot copy, and loads the log file to form the cloned block device.

The read traffic control during the first execution stage is different from the read traffic control after the downloading of the snapshot copy is completed in the second execution stage. In the lazy load stage, the main read is from the memory cache or from the object storage. Therefore, the traffic is only related to the number of nodes in the cluster, and the traffic dispersion in the lazy load stage may be completely dispersed on all nodes, and all block devices in the lazy load stage share the same bandwidth. In the second execution stage after the snapshot copy is downloaded, although the traffic may be dispersed on all nodes, the traffic of a single data block will still be limited by the service thread and the hard disk bandwidth, thus affecting the read performance of the block device. In this embodiment, since a plurality of snapshot copies are stored in the elastic block storage, accordingly, log files corresponding to the plurality of snapshot copies will be formed in the file storage system, which is equivalent to increasing the total bandwidth resource supply, thereby reducing the impact of the bandwidth resource limitation on the data transmission performance when the block device accesses the above log files, thereby improving the performance of the block device.

FIG. 4 is a schematic diagram of a process of connecting a block device to a plurality of snapshot copies according to an embodiment of the present disclosure. As shown in FIG. 4, exemplarily, after the block device sends the download request to the image center, a plurality of snapshot backups are downloaded in the elastic block storage (EBS cluster), and the snapshot backups are stored in the distributed file storage system in the form of log files. In a process of continuously creating block devices in the elastic block storage (shown as Device in the figure), each block device is connected to the corresponding snapshot backup, and obtains the corresponding log file through the distributed file storage system, so that each block device can load the above log file with a larger reading traffic, so as to quickly complete the block device cloning and improve the performance of the block device.

In this embodiment, after receiving the lazy load request sent by the virtual machine in the elastic computing service cluster to the block device located in the elastic block storage, the target snapshot data is acquired, and the snapshot download request is sent to the image center to download at least two snapshot copies, where the block device is used to store the data resource required for starting the virtual machine, the snapshot copy is the image data of the data resource required for starting the virtual machine, and the target snapshot data is the data resource required for running the target function of the virtual machine; each block device is connected to the corresponding snapshot copy to obtain the log file corresponding to the snapshot copy; and the log file corresponding to the snapshot copy is loaded through the block device to form the cloned block device, and the virtual machine is started based on the cloned block device. By downloading a plurality of snapshot copies from the image center during lazy loading, log files corresponding to a plurality of groups of snapshot copies are formed in the file storage system, so that the block device can obtain the required data resources from the plurality of groups of log files respectively to form the cloned block device, thereby avoiding the problem of read hotspot formed in the block device and improving the performance of the block device.

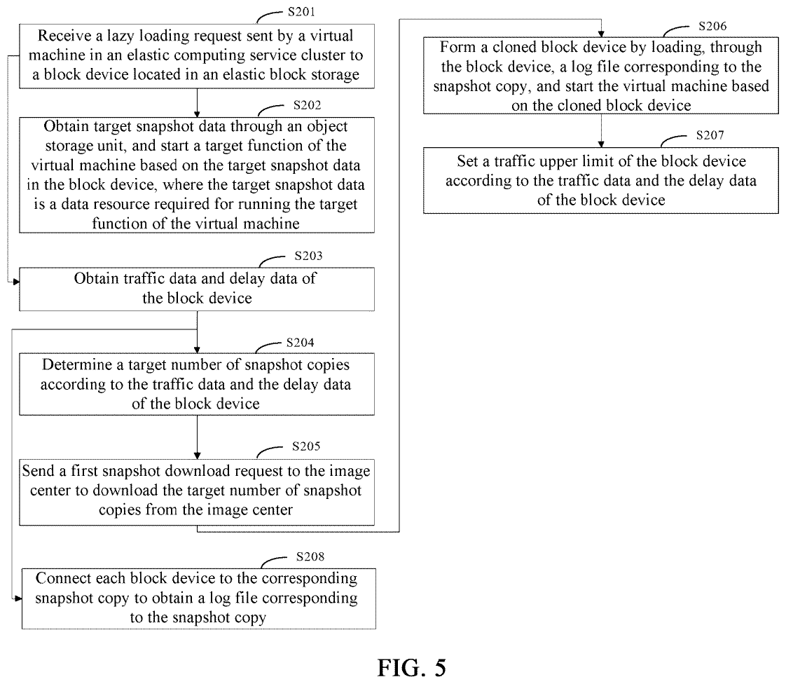

Referring to FIG. 5, FIG. 5 is schematic flowchart 2 of a method for controlling virtual machine starting based on a cloned block device according to an embodiment of the present disclosure. Based on the embodiment shown in FIG. 2, this embodiment further adds steps of determining the number of snapshot copies and setting the traffic upper limit of the block device. The method for controlling virtual machine starting based on a cloned block device includes the following steps.
Step S201: A lazy load request sent by a virtual machine in an elastic computing service cluster to a block device located in elastic block storage is received.
Step S202: Target snapshot data through an object storage unit is acquired, and a target function of the virtual machine is started based on the target snapshot data in the block device, where the target snapshot data is a data resource required for running the target function of the virtual machine.
Step S203: Traffic data and delay data of the block device are acquired.
Step S204: A target number of the snapshot copies is determined according to the traffic data and the delay data of the block device.

Exemplarily, in this embodiment, before the snapshot download request is sent to the image center, the number of snapshot copies to be downloaded is determined first. Since the number of block devices created by the user/virtual machine (the number of created block devices) is uncertain, how to determine an appropriate number of snapshot copies will directly affect the final performance of the block device. Specifically, the traffic data is data representing the current real-time traffic of the block device, such as 30 megabits per second (Mb/s). The delay data is data representing the delay of the block device, such as 39 microseconds (s). In a possible implementation, the target number of snapshot copies may be determined directly by comparing the magnitude relationship between the traffic data and the delay data of the block device and the corresponding traffic threshold and delay threshold. For example, the greater the traffic data of the block device exceeds the traffic threshold (that is, the traffic is too large), the more the target number of snapshot copies, or the greater the increase based on the current number of snapshot copies; and/or, the greater the delay data of the block device exceeds the delay threshold (that is, the delay is too large), the more the target number of snapshot copies, or the greater the increase based on the current number of snapshot copies.

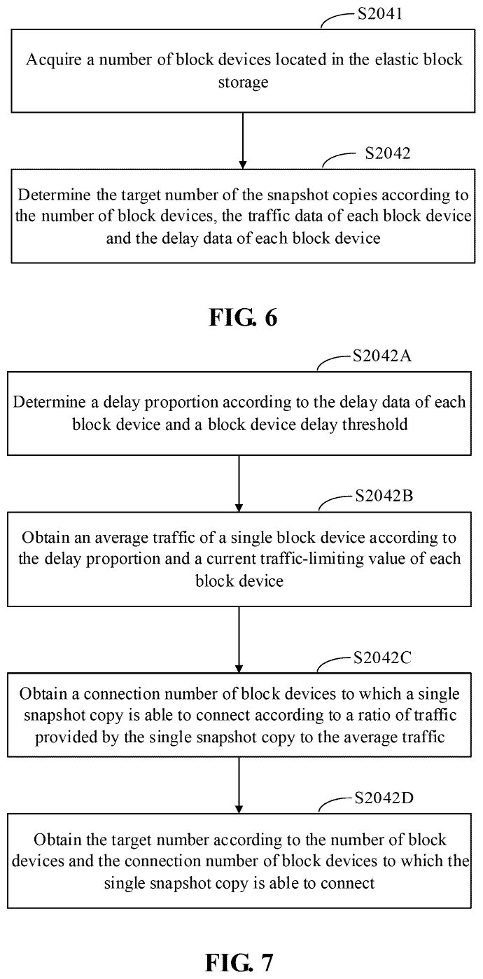

In a possible implementation, as shown in FIG. 6, the specific implementation of step S204 includes the following steps.
Step S2041: A number of block devices located in the elastic block storage is acquired.
Step S2042: The target number of snapshot copies is determined according to the number of block devices, traffic data of each block device and delay data of each block device.

Exemplarily, in another possible implementation, an optimized target number may be comprehensively calculated by combining the number of block devices currently located in the elastic block storage, that is, the number of created block devices, and the traffic data and delay data of each disk, so that the number of snapshot copies is more reasonable. For example, the average traffic required for a single block device is evaluated according to the traffic data and the delay data respectively, and then the total traffic required for the block device is obtained by combining the number of block devices; and then the number of snapshot copies is obtained according to a proportion of the total traffic required for the block device to the traffic that can be provided by a single snapshot copy.

Further, in another possible implementation, as shown in FIG. 7, the specific implementation of step S2042 includes the following steps.
Step S2042A: A delay proportion is determined according to the delay data of each block device and a block device delay threshold.
Step S2042B: An average traffic of a single block device is obtained according to the delay proportion and the current traffic-limiting value of each block device.
Step S2052C: The connection number of block devices to which a single snapshot copy is able to connect is obtained according to a ratio of traffic provided by the single snapshot copy to the average traffic.
Step S2052D: The target number is obtained according to the number of block devices and the connection number of block devices to which the single snapshot copy is able to connect.

Exemplarily, after the lazy load request is sent, if a plurality of snapshots create disks at the same time, the plurality of snapshots and a plurality of disks will share the lazy load bandwidth. In this scenario, the bandwidth of a single snapshot copy may not necessarily trigger the traffic threshold for expanding the copy, but the traffic actually required for the block device is still large. Therefore, when the traffic is dispersed during lazy loading, it is considered that the lazy load traffic is allocated to each block device during lazy loading to ensure the traffic stability, and the delay can be correspondingly converted based on the traffic traffic-limiting. Specifically, when the traffic-limiting is insufficient to support the traffic of the block device, the corresponding average delay increases, and we can reversely deduce how much traffic the block device needs to support from the delay and determine how many copies are correspondingly needed for support. Assuming that the current traffic-limiting is 30 MB/s, the average delay of the block device without triggering the traffic-limiting is 400 us, when the traffic-limiting occurs and the average delay rises to 800 us, and the IO is in the queue, the expected traffic needs to be almost 60 MB/s.

Based on the above example, the amount of traffic required can be estimated according to the lazy load traffic-limiting and the block device delay, and then the number of copies can be confirmed. Specifically, Formula (1) is used to calculate the connection number M_{T} of block devices to which the single snapshot copy is able to connect, as shown in Formula (1):

$${M}_{T} = Z * S / ( ( {\sum }_{0 < j < n} Y / X * {V}_{j} ) / n ) \qquad ( 1 )$$

where X is the average delay without triggering the traffic-limiting;
Y is the current average delay of the single block device;
V is the current traffic-limiting of the single block device;
S is the traffic that can be provided by the single copy;
Z is the traffic use factor;
T is the time; and
n is the number of block devices.

Firstly, the delay proportion is obtained according to the ratio of the delay data of each block device to the delay threshold of the block device without triggering the traffic-limiting, that is, Y/X. Then, the average traffic of a single block device is obtained according to the accumulated value of the product of the delay proportion and the current traffic-limiting values of respective block devices, that is, the product of the delay proportion and the traffic-limiting V of the single block device is calculated, and the product is accumulated for all block devices to obtain the accumulated sum. Then, the accumulated sum is divided by the number 11 of block devices to obtain the average traffic of each block device according to the accumulated value of the product of the delay proportion and the current traffic-limiting value of each block device when the block device is in stable operation. Thereafter, the product of the traffic S that can be provided by the single copy and the use factor Z is calculated, where Z is, for example, 0.8, representing the actual usage rate, to obtain the actual traffic that can be provided by the single copy. Thereafter, the ratio of the actual traffic to the average traffic is calculated to obtain the connection number M_{T}. Finally, the target number is obtained according to the ratio of the number of block devices to the connection number of block devices to which the single snapshot copy is able to connect. For example, if the actual traffic that can be provided by the single copy is 1000 Mb/S, and the average traffic of the single block device is 50 Mb/S, the connection number of block devices to which the single snapshot copy is able to connect is 20. If the current number of block devices is 100, the target number is determined as 5 by the ratio of the current number of block devices 100 to the connection number 20.

Further, in a possible implementation, it is further necessary to control the connection number M_{T} within an appropriate range, that is, less than the maximum connection number and greater than the minimum connection number. The maximum connection number may be determined by the minimum set traffic value of the single block device; and the minimum connection number may be determined by the maximum set traffic value of the single block device, which will not be repeated here.

Step S205: A first snapshot download request is sent to the image center to download the target number of snapshot copies from the image center.

It should be noted that the step of sending the first snapshot download request to the image center in the step of this embodiment may be repeatedly executed multiple times, that is, in the process of lazy loading performed by the block device, the real-time target number of snapshot copies will be determined according to the current number of block devices, the traffic data of each block device, and the delay data of each block device, thereby realizing the dynamic adjustment of the snapshot copies.
Step S206: Each block device is connected to a corresponding snapshot copy to obtain log files corresponding to the snapshot copies respectively.
Step S207: A cloned block device is formed by loading, through the cloud disk, a log file corresponding to the snapshot copy, and the virtual machine is started based on the cloned block device.

Optionally, this embodiment further includes the following step.

Step S208: the traffic upper limit of the block device is set according to the traffic data and the delay data of the block device.

In a possible implementation, while dynamically setting the snapshot copies, the traffic upper limit of the block device may be further dynamically set according to the traffic data and the delay data of the block device, thereby avoiding the problem that the traffic of a single block device is too large or too small, and improving the utilization of the bandwidth of the block device. For example, the traffic data of the block device is S, and the delay data of the block device is D. Specifically:
when S=the traffic upper limit, and D>X, the traffic upper limit of the block device is increased;
when S<the traffic upper limit, and D=X, the traffic upper limit of the block device is decreased; and
when S<the traffic upper limit, and D>X, the traffic upper limit of the block device is kept.
X is the block device delay threshold. Through the above method, the adjustment of the traffic upper limit can be realized.

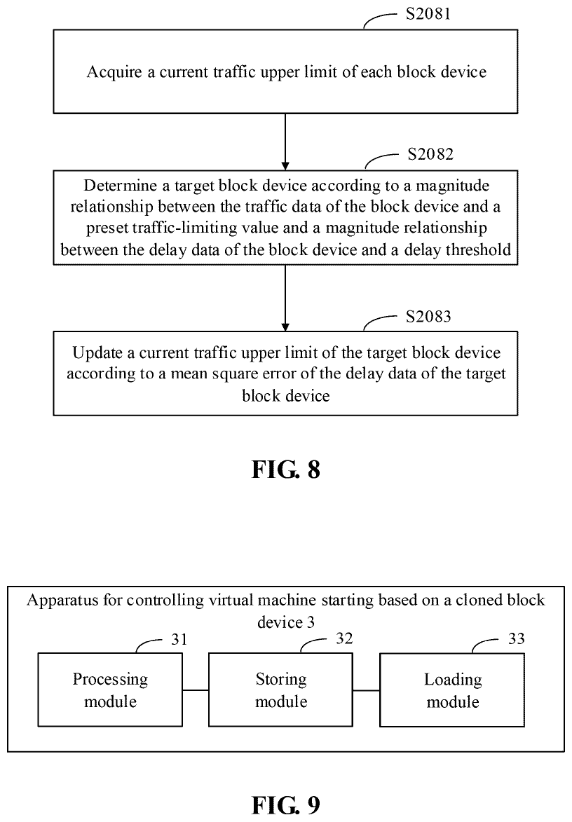

Exemplarily, as shown in FIG. 8, the specific implementation of step S208 includes the following steps.
Step S2081: A current traffic upper limit of each block device is acquired.
Step S2082: The target block device is determined according to a magnitude relationship between the traffic data of the block device and a preset traffic-limiting value and a magnitude relationship between the delay data of the block device and a delay threshold.
Step S2083: The current traffic upper limit of the target block device is updated according to the mean square error of the delay data of the target block device.

Exemplarily, firstly, the delay data of the block device is expressed as X. After acquiring the current traffic upper limit of each block device, the block device that needs to increase the traffic upper limit of the block device and the block device that needs to decrease the traffic upper limit of the block device may be determined as the target block device by the method in the above example, and this process will not be repeated here. Thereafter, the mean square error of the delay of all target block devices is calculated, and if the mean square error is less than the mean square error threshold, no adjustment is performed; if the mean square error is greater than the mean square error threshold, adjustment is performed, where the specific implementation of the mean square error threshold may be set according to the service requirements, which is not limited here.

Further, the method further includes the following steps.
Step S2080A: A service basic coefficient is acquired, where the service basic coefficient is used to characterize a service level corresponding to the virtual machine.
Step S2080B: The delay threshold is obtained according to the service basic coefficient and an average delay of each block device.

Further, in order to consider the priority dimension of the user, in the step of this embodiment, the block device delay threshold may be adjusted by further adding the weight coefficient. The higher the priority of the user is, the lower the weight coefficient is, so that important users and services may obtain a larger elasticity coefficient. Exemplarily, the priority includes three levels, which are: high: basic coefficient 0.8, Mid: basic coefficient 0.9, and Low: basic coefficient 1.0. The block device delay threshold combined with the service level is defined by calculating the basic coefficient*the average delay. Thereby, the performance of the block device corresponding to the important user and the service is improved.

In this embodiment, the implementation of step S201 and step S202 is the same as the implementation of step S101 and step S102 in the embodiment shown in FIG. 2 of the present disclosure, which will not be repeated here.

Corresponding to the method for controlling virtual machine starting based on a cloned block device in the above embodiment, FIG. 9 is a block diagram of a structure of an apparatus for controlling virtual machine starting based on a cloned block device according to an embodiment of the present disclosure. The method described in the above embodiment may be executed by the apparatus for controlling virtual machine starting based on a cloned block device, and the apparatus may be implemented by software and/or hardware, and the apparatus may be integrated into an electronic device with a certain data processing function. The electronic device may include, but is not limited to, a mobile terminal with big data processing capability, and a fixed terminal with big data processing capability such as a desktop computer and a supercomputer.

For ease of description, only parts related to the embodiments of the present disclosure are shown. Referring to FIG. 9, the apparatus 3 for controlling virtual machine starting based on a cloned block device includes:
a processing module 31, configured to, after receiving a lazy load request sent by a virtual machine in an elastic computing service cluster to a block device located in elastic block storage, acquire target snapshot data, and send a snapshot download request to an image center to download at least two snapshot copies, where the block device is used to store a data resource required for starting the virtual machine, a snapshot copy is image data of the data resource required for starting the virtual machine, and the target snapshot data is a data resource required for running a target function of the virtual machine;
a storage module 32, configured to connect each block device to a corresponding snapshot copy to obtain log files corresponding to the at least two snapshot copies respectively; and
a loading module 33, configured to form a cloned block device by loading, through the block device, a log file corresponding to the snapshot copy, and start the virtual machine based on the cloned block device.

According to one or more embodiments of the present disclosure, when acquiring the target snapshot data, the processing module 31 is further configured to: send a data read request for the target snapshot data to an object storage unit; and receive the target snapshot data, and write the target snapshot data into the block device. The method further includes: starting a target function of the virtual machine based on the target snapshot data in the block device.

According to one or more embodiments of the present disclosure, after acquiring the target snapshot data, the processing module 31 is further configured to: acquire traffic data and delay data of the block device; and determine a target number of the snapshot copies according to the traffic data and the delay data of the block device. When sending the snapshot download request to the image center, the processing module 31 is further configured to: send a first snapshot download request to the image center to download the target number of snapshot copies from the image center.

According to one or more embodiments of the present disclosure, when determining the target number of the snapshot copies according to the traffic data and the delay data of the block device, the processing module 31 is further configured to: acquire a number of block devices located in the elastic block storage; and determine the target number of the snapshot copies according to the number of block devices, the traffic data of each block device and the delay data of each block device.

According to one or more embodiments of the present disclosure, when determining the target number of the snapshot copies according to the number of block devices, the traffic data of each block device and the delay data of each block device, the processing module 31 is further configured to: determine a delay proportion according to the delay data of each block device and a block device delay threshold; obtain an average traffic of a single block device according to the accumulated value of the product of the delay proportion and the current traffic-limiting value of each block device; obtain a connection number of block devices to which a single snapshot copy is able to connect according to a ratio of traffic provided by the single snapshot copy to the average traffic; and obtain the target number according to the number of block devices and the connection number of block devices to which the single snapshot copy is able to connect.

According to one or more embodiments of the present disclosure, the storage module 32 is further configured to: send an image data read request to a distributed file storage system through the block device; and acquire, through the file storage system, the log file corresponding to the snapshot copy, and send the log file to the corresponding block device.

According to one or more embodiments of the present disclosure, before connecting each of the block devices to the corresponding snapshot copy to obtain the log file corresponding to the snapshot copy, the processing module 31 is further configured to: acquire traffic data and delay data of the block device; and set a traffic upper limit of the block device according to the traffic data and the delay data of the block device.

According to one or more embodiments of the present disclosure, when setting the traffic upper limit of the block device according to the traffic data and the delay data of the block device, the processing module 31 is further configured to: acquire a current traffic upper limit of each block device; and determine a target block device according to a magnitude relationship between the traffic data of the block device and a preset traffic-limiting value and a magnitude relationship between the delay data of the block device and a delay threshold, and set the current traffic upper limit of the target block device.

According to one or more embodiments of the present disclosure, the processing module 31 is further configured to: acquire a service basic coefficient, where the service basic coefficient is used to characterize a service level corresponding to the virtual machine; and obtain the delay threshold according to the service basic coefficient.

The processing module 31, the storage module 32, and the loading module 33 are connected in sequence. The apparatus 3 for controlling virtual machine starting based on a cloned block device provided in this embodiment can execute the technical solutions of the above method embodiments, and the implementation principles and technical effects thereof are similar, which will not be repeated here in this embodiment.

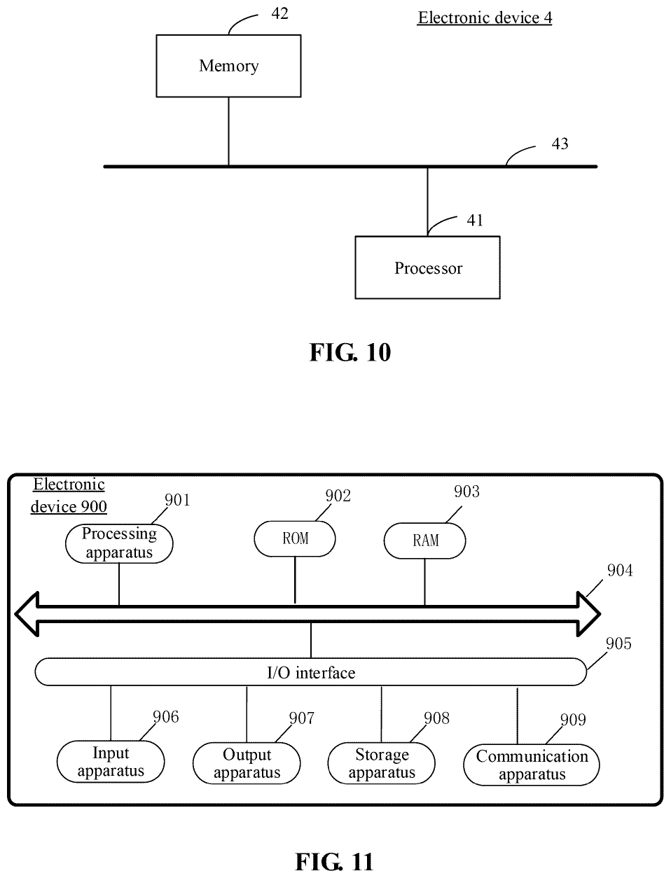

FIG. 10 is a schematic diagram of a structure of an electronic device according to an embodiment of the present disclosure. As shown in FIG. 10, the electronic device 4 includes:
a processor 41, and a memory 42 communicatively connected to the processor 41;
where the memory 42 stores computer-executable instructions; and
the processor 41 executes the computer-executable instructions stored in the memory 42 to implement the method for controlling virtual machine starting based on a cloned block device in the embodiments shown in FIG. 2 to FIG. 8.

Optionally, the processor 41 and the memory 42 are connected through a bus 43.

For related explanations, reference may be made to the related descriptions and effects corresponding to the steps in the embodiments corresponding to FIG. 2 to FIG. 8 for understanding, which will not be repeated here.

An embodiment of the present disclosure provides a computer-readable storage medium, where computer-executable instructions are stored in the computer-readable storage medium, and when the computer-executable instructions are executed by a processor, the method for controlling virtual machine starting based on a cloned block device provided by any of the embodiments corresponding to FIG. 2 to FIG. 8 of the present disclosure is implemented.

An embodiment of the present disclosure provides a computer program product, including a computer program, where when the computer program is executed by a processor, the method for controlling virtual machine starting based on a cloned block device provided by any of the embodiments corresponding to FIG. 2 to FIG. 8 of the present disclosure is implemented.

In order to implement the above embodiments, an embodiment of the present disclosure further provides an electronic device.

Referring to FIG. 11, it shows a schematic diagram of a structure of an electronic device 900 suitable for implementing the embodiments of the present disclosure, and the electronic device 900 may be a terminal device or a server. The terminal device may include, but is not limited to, a mobile terminal such as a mobile phone, a laptop, a digital broadcast receiver, a personal digital assistant (PDA), a tablet computer, a portable media player (PMP), a vehicle-mounted terminal (such as a vehicle-mounted navigation terminal), etc., and a fixed terminal such as a digital TV, a desktop computer, etc. The electronic device shown in FIG. 11 is only an example, and should not bring any limitation to the function and usage scope of the embodiments of the present disclosure.

As shown in FIG. 11, the electronic device 900 may include a processing apparatus (such as a central processor, a graphics processor, etc.) 901, which may perform various appropriate actions and processing according to a program stored in a read-only memory (ROM) 902 or a program loaded from a storage apparatus 908 into a random access memory (RAM) 903. Various programs and data required for the operation of the electronic device 900 are also stored in the RAM 903. The processing apparatus 901, the ROM 902, and the RAM 903 are connected to each other through a bus 904. An input/output (I/O) interface 905 is also connected to the bus 904.

Generally, the following apparatuses may be connected to the I/O interface 905: an input apparatus 906 including, for example, a touch screen, a touch pad, a keyboard, a mouse, a camera, a microphone, an accelerometer, a gyroscope, etc.; an output apparatus 907 including, for example, a liquid crystal display (LCD), a speaker, a vibrator, etc.; a storage apparatus 908 including, for example, a magnetic tape, a hard disk, etc.; and a communication apparatus 909. The communication apparatus 909 may allow the electronic device 900 to perform wireless or wired communication with other devices to exchange data. Although FIG. 11 shows the electronic device 900 having various apparatuses, it should be understood that it is not required to implement or have all of the illustrated apparatuses. More or fewer apparatuses may be implemented or provided alternatively.

In particular, according to the embodiments of the present disclosure, the processes described above with reference to the flowcharts may be implemented as computer software programs. For example, an embodiment of the present disclosure includes a computer program product, which includes a computer program carried on a computer-readable medium, where the computer program includes program codes for executing the methods shown in the flowcharts. In such an embodiment, the computer program may be downloaded and installed from a network through the communication apparatus 909, or installed from the storage apparatus 908, or installed from the ROM 902. When the computer program is executed by the processing apparatus 901, the above functions defined in the methods of the embodiments of the present disclosure are executed.

It should be noted that the computer-readable medium in the present disclosure may be a computer-readable signal medium or a computer-readable storage medium, or any combination thereof. The computer-readable storage medium may be, for example, but not limited to, an electrical, magnetic, optical, electromagnetic, infrared, or semiconductor system, apparatus or device, or any combination thereof. More specific examples of the computer-readable storage medium may include, but are not limited to: an electrical connection with one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, a computer-readable storage medium may be any tangible medium that contains or stores a program that can be used by or in combination with an instruction execution system, apparatus or device. In the present disclosure, a computer-readable signal medium may include a data signal propagated in a baseband or as a part of a carrier, and computer-readable program codes are carried in the data signal. The data signal propagated in this manner may be in various forms, including but not limited to an electromagnetic signal, an optical signal, or any suitable combination thereof. The computer-readable signal medium may also be any computer-readable medium other than the computer-readable storage medium. The computer-readable signal medium may send, propagate, or transmit a program used by or in combination with an instruction execution system, apparatus, or device. The program codes contained on the computer-readable medium may be transmitted by any suitable medium, including but not limited to: a wire, an optical cable, a radio frequency (RF), etc., or any suitable combination thereof.

The above computer-readable medium may be contained in the above electronic device; or may also exist alone without being assembled into the electronic device.

The above computer-readable medium carries one or more programs, and when the above one or more programs are executed by the electronic device, the electronic device is caused to execute the methods shown in the above embodiments.

The computer program codes for executing the operations in the present disclosure may be written in one or more programming languages or a combination thereof. The above one or more programming languages include object-oriented programming languages such as Java, Smalltalk, C++, and also conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any kind of network, including a Local Area Network (LAN) or a Wide Area Network (WAN), or the connection may be made to an external computer (for example, through the Internet using an Internet service provider).

The flowcharts and block diagrams in the drawings illustrate the possible architecture, functionality and operation of the system, method and computer program product according to various embodiments of the present disclosure. In this regard, each block in the flowcharts or block diagrams may represent a module, a program segment, or a part of codes, and the module, the program segment, or the part of codes contains one or more executable instructions for implementing specified logical functions. It should also be noted that, in some alternative implementations, the functions noted in the blocks may also occur in an order different from those noted in the drawings. For example, two blocks shown in succession may, in fact, be executed substantially concurrently, or the two blocks may sometimes be executed in a reverse order, depending upon the functionality involved. It should also be noted that, each block of the block diagrams and/or flowcharts and combinations of blocks in the block diagrams and/or flowcharts may be implemented by a dedicated hardware-based system that performs the specified functions or operations, or may also be implemented by a combination of dedicated hardware and computer instructions.

The units or modules involved in the embodiments described in the present disclosure may be implemented by software or hardware. The name of the unit or module does not constitute a limitation of the unit itself under certain circumstances.

The functions described herein above may be performed, at least in part, by one or more hardware logic components. For example, and without limitation, exemplary types of hardware logic components that can be used include: a field programmable gate array (FPGA), an application specific integrated circuit (ASIC), an application specific standard product (ASSP), a system on chip (SOC), a complex programmable logical device (CPLD), etc.

In the context of the present disclosure, a machine-readable medium may be a tangible medium that may include or store a program for use by or in conjunction with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof.

In a first aspect, according to one or more embodiments of the present disclosure, there is provided a method for controlling virtual machine starting based on a cloned block device, including:
receiving a lazy load request sent by a virtual machine in an elastic computing service cluster to a block device located in elastic block storage, acquiring target snapshot data, and sending a snapshot download request to an image center to download at least two snapshot copies, where the block device is used to store a data resource required for starting the virtual machine, a snapshot copy is image data of the data resource required for starting the virtual machine, and the target snapshot data is a data resource required for running a target function of the virtual machine; connecting each of the block devices to a corresponding snapshot copy to obtain log files corresponding to the at least two snapshot copies respectively; and forming a cloned block device by loading, through the block device, a log file corresponding to the snapshot copy, and starting the virtual machine based on the cloned block device.

According to one or more embodiments of the present disclosure, acquiring target snapshot data includes: sending a data read request for the target snapshot data to an object storage unit; and receiving the target snapshot data, and writing the target snapshot data into the block device. The method further includes: starting a target function of the virtual machine based on the target snapshot data in the block device.

According to one or more embodiments of the present disclosure, after acquiring the target snapshot data, the method further includes: acquiring traffic data and delay data of the block device; and determining a target number of the snapshot copies according to the traffic data and the delay data of the block device. Sending the snapshot download request to the image center includes: sending a first snapshot download request to the image center to download the target number of snapshot copies from the image center.

According to one or more embodiments of the present disclosure, determining the target number of the snapshot copies according to the traffic data and the delay data of the block device includes: acquiring a number of block devices located in the elastic block storage; and determining the target number of the snapshot copies according to the number of block devices, the traffic data of each block device and the delay data of each block device.

According to one or more embodiments of the present disclosure, determining the target number of the snapshot copies according to the number of block devices, the traffic data of each block device and the delay data of each block device includes: determining a delay proportion according to the delay data of each block device and a block device delay threshold; obtaining an average traffic of a single block device according to the delay proportion and the current traffic-limiting value of each block device; obtaining a connection number of block devices to which a single snapshot copy is able to connect according to a ratio of traffic provided by the single snapshot copy to the average traffic; and obtaining the target number according to the number of block devices and the connection number of block devices to which the single snapshot copy is able to connect.

According to one or more embodiments of the present disclosure, connecting each block device to the corresponding snapshot copy to obtain the log files corresponding to the at least two snapshot copies respectively includes: sending an image data read request to a distributed file storage system through the block device; and acquiring, through the file storage system, the log file corresponding to the snapshot copy, and sending the log file to the corresponding block device.

According to one or more embodiments of the present disclosure, before connecting each block device to the corresponding snapshot copy to obtain the log files corresponding to the at least two snapshot copies respectively, the method further includes: acquiring traffic data and delay data of the block device; and setting a traffic upper limit of the block device according to the traffic data and the delay data of the block device.

According to one or more embodiments of the present disclosure, setting the traffic upper limit of the block device according to the traffic data and the delay data of the block device includes: acquiring a current traffic upper limit of each block device; and determining a target block device according to a magnitude relationship between the traffic data of the block device and a preset traffic-limiting value and a magnitude relationship between the delay data of the block device and a delay threshold, and setting the current traffic upper limit of the target block device.

According to one or more embodiments of the present disclosure, the method further includes: acquiring a service basic coefficient, where the service basic coefficient is used to characterize a service level corresponding to the virtual machine; and obtaining the delay threshold according to the service basic coefficient.

In a second aspect, according to one or more embodiments of the present disclosure, an apparatus for controlling virtual machine starting based on a cloned block device is provided, including:
a processing module, configured to, after receiving a lazy load request sent by a virtual machine in an elastic computing service cluster to a block device located in elastic block storage, acquire target snapshot data, and send a snapshot download request to an image center to download at least two snapshot copies, where the block device is used to store a data resource required for starting the virtual machine, a snapshot copy is image data of the data resource required for starting the virtual machine, and the target snapshot data is a data resource required for running a target function of the virtual machine;
a storage module, configured to connect each of the block devices to a corresponding snapshot copy to obtain log files corresponding to the at least two snapshot copies respectively; and
a loading module, configured to form a cloned block device by loading, through the block device, a log file corresponding to the snapshot copy, and start the virtual machine based on the cloned block device.

According to one or more embodiments of the present disclosure, when acquiring the target snapshot data, the processing module is further configured to: send a data read request for the target snapshot data to an object storage unit; and receive the target snapshot data, and write the target snapshot data into the block device. The method further includes: starting a target function of the virtual machine based on the target snapshot data in the block device.

According to one or more embodiments of the present disclosure, after acquiring the target snapshot data, the processing module is further configured to: acquire traffic data and delay data of the block device; and determine a target number of the snapshot copies according to the traffic data and the delay data of the block device. When sending the snapshot download request to the image center, the processing module is further configured to: send a first snapshot download request to the image center to download the target number of snapshot copies from the image center.

According to one or more embodiments of the present disclosure, when determining the target number of the snapshot copies according to the traffic data and the delay data of the block device, the processing module is further configured to: acquire a number of block devices located in the elastic block storage; and determine the target number of the snapshot copies according to the number of block devices, the traffic data of each block device and the delay data of each block device.

According to one or more embodiments of the present disclosure, when determining the target number of the snapshot copies according to the number of block devices, the traffic data of each block device and the delay data of each block device, the processing module is further configured to: determine a delay proportion according to the delay data of each block device and a block device delay threshold; obtain an average traffic of a single block device according to the delay proportion and the current traffic-limiting value of each block device; obtain a connection number of block devices to which a single snapshot copy is able to connect according to a ratio of traffic provided by the single snapshot copy to the average traffic; and obtain the target number according to the number of block devices and the connection number of block devices to which the single snapshot copy is able to connect.

According to one or more embodiments of the present disclosure, the storage module is further configured to: send an image data read request to a distributed file storage system through the block device; and acquire, through the file storage system, the log file corresponding to the snapshot copy, and send the log file to the corresponding block device.

According to one or more embodiments of the present disclosure, before connecting each block device to the corresponding snapshot copy to obtain the log files corresponding to the at least two snapshot copies respectively, the processing module is further configured to: acquire traffic data and delay data of the block device; and set a traffic upper limit of the block device according to the traffic data and the delay data of the block device.

According to one or more embodiments of the present disclosure, when setting the traffic upper limit of the block device according to the traffic data and the delay data of the block device, the processing module is further configured to: acquire a current traffic upper limit of each block device; and determine the target block device according to a magnitude relationship between the traffic data of the block device and the preset traffic-limiting value and a magnitude relationship between the delay data of the block device and a delay threshold, and set the current traffic upper limit of the target block device.

According to one or more embodiments of the present disclosure, the processing module is further configured to: acquire the service basic coefficient, where the service basic coefficient is used to characterize the service level corresponding to the virtual machine; and obtain the delay threshold according to the service basic coefficient.

In a third aspect, according to one or more embodiments of the present disclosure, there is provided an electronic device, including: at least one processor and a memory; where the memory stores computer-executable instructions; and the at least one processor executes the computer-executable instructions stored in the memory, to enable the at least one processor to execute the method for controlling virtual machine starting based on a cloned block device in the first aspect and various possible designs of the first aspect.

In a fourth aspect, according to one or more embodiments of the present disclosure, there is provided a computer-readable storage medium, where computer-executable instructions are stored in the computer-readable storage medium, and when the computer-executable instructions are executed by a processor, the method for controlling virtual machine starting based on a cloned block device in the first aspect and various possible designs of the first aspect is implemented.

In a fifth aspect, according to one or more embodiments of the present disclosure, there is provided a computer program product, including a computer program, where when the computer program is executed by a processor, the method for controlling virtual machine starting based on a cloned block device in the first aspect and various possible designs of the first aspect is implemented.

The above description is only preferred embodiments of the present disclosure and an explanation of the applied technical principles. Those skilled in the art should understand that the scope of disclosure involved in the present disclosure is not limited to the technical solutions formed by the specific combination of the above technical features, and should also cover other technical solutions formed by any combination of the above technical features or equivalent features thereof without departing from the above disclosed concept. For example, the above features and technical features with similar functions disclosed in the present disclosure (but not limited to) are replaced with each other to form a technical solution.

In addition, although operations are depicted in a particular order, this should not be understood as requiring these operations to be performed in the specific order shown or in a sequential order. Under certain circumstances, multitasking and parallel processing may be advantageous. Likewise, although the above discussion includes several specific implementation details, these should not be interpreted as limiting the scope of the present disclosure. Certain features that are described in the context of separate embodiments may also be implemented in combination in a single embodiment. Conversely, various features that are described in the context of a single embodiment may also be implemented in multiple embodiments individually or in any suitable sub-combination.

Although the subject matter has been described in language specific to structural features and/or logical actions of the method, it should be understood that the subject matter defined in the appended claims is not necessarily limited to the specific features or actions described above. Conversely, the specific features and actions described above are only example forms for implementing the claims.

I/We claim:

1. A method for controlling virtual machine starting based on a cloned block device, comprising:
receiving a lazy load request sent by a virtual machine to a block device of elastic block storage, acquiring target snapshot data, and sending a snapshot download request to an image center to download at least two snapshot copies, wherein the block device is used to store a data resource required for starting the virtual machine, a snapshot copy is image data of the data resource required for starting the virtual machine, and the target snapshot data is a data resource required for running a target function of the virtual machine;
connecting each block device to a corresponding snapshot copy to obtain log files corresponding to the at least two snapshot copies respectively; and
forming a cloned block device by loading, through the block device, a log file corresponding to the snapshot copy, and starting the virtual machine based on the cloned block device.

2. The method of claim 1, wherein acquiring the target snapshot data comprises:
sending a data read request for the target snapshot data to an object storage unit; and
receiving the target snapshot data, and writing the target snapshot data into the block device; and
the method further comprises: starting the target function of the virtual machine based on the target snapshot data in the block device.

3. The method of claim 1, wherein after acquiring the target snapshot data, the method further comprises:
acquiring traffic data and delay data of the block device; and
determining a target number of the snapshot copies according to the traffic data and the delay data of the block device; and
sending the snapshot download request to the image center comprises:
sending a first snapshot download request to the image center to download the target number of snapshot copies from the image center.

4. The method of claim 3, wherein determining the target number of the snapshot copies according to the traffic data and the delay data of the block device comprises:
acquiring a number of block devices located in the elastic block storage; and
determining the target number of the snapshot copies according to the number of block devices, the traffic data of each block device and the delay data of each block device.

5. The method of claim 4, wherein determining the target number of the snapshot copies according to the number of block devices, the traffic data of each block device and the delay data of each block device comprises:
determining a delay proportion according to the delay data of each block device and a block device delay threshold;
obtaining an average traffic of a single block device according to the delay proportion and a current traffic-limiting value of each block device;
obtaining a connection number of block devices to which a single snapshot copy is able to connect according to a ratio of traffic provided by the single snapshot copy to the average traffic; and
obtaining the target number according to the number of block devices and the connection number of block devices to which the single snapshot copy is able to connect.

6. The method of claim 1, wherein connecting each block device to the corresponding snapshot copy to obtain the log files corresponding to the at least two snapshot copies respectively comprises:
sending an image data read request to a distributed file storage system through the block device; and
acquiring, through the file storage system, the log file corresponding to the snapshot copy, and sending the log file to the corresponding block device.

7. The method of claim 1, wherein before connecting each block device to the corresponding snapshot copy to obtain the log files corresponding to the at least two snapshot copies respectively, the method further comprises:
acquiring traffic data and delay data of the block device; and
setting a traffic upper limit of the block device according to the traffic data and the delay data of the block device.

8. The method of claim 7, wherein setting the traffic upper limit of the block device according to the traffic data and the delay data of the block device comprises:
acquiring a current traffic upper limit of each block device; and
determining a target block device according to a magnitude relationship between the traffic data of the block device and a preset traffic-limiting value and a magnitude relationship between the delay data of the block device and a delay threshold, and setting the current traffic upper limit of the target block device.

9. The method of claim 8, wherein the method further comprises:
acquiring a service basic coefficient, wherein the service basic coefficient is used to characterize a service level corresponding to the virtual machine; and
obtaining the delay threshold according to the service basic coefficient and an average delay of each block device.

10. An electronic device, comprising:
a processor and a memory;
wherein the memory stores computer-executable instructions; and
the computer-executable instructions, when executed by the processor, cause the processor to:
receive a lazy load request sent by a virtual machine to a block device of elastic block storage, acquire target snapshot data, and send a snapshot download request to an image center to download at least two snapshot copies, wherein the block device is used to store a data resource required for starting the virtual machine, a snapshot copy is image data of the data resource required for starting the virtual machine, and the target snapshot data is a data resource required for running a target function of the virtual machine;
connect each block device to a corresponding snapshot copy to obtain log files corresponding to the at least two snapshot copies respectively; and
form a cloned block device by loading, through the block device, a log file corresponding to the snapshot copy, and start the virtual machine based on the cloned block device.

11. The electronic device of claim 10, wherein the computer-executable instructions for acquiring the target snapshot data comprise a computer-executable instruction which, when executed by the processor, causes the processor to:
send a data read request for the target snapshot data to an object storage unit; and
receive the target snapshot data, and write the target snapshot data into the block device; and
wherein the computer-executable instructions further cause the processor to: start the target function of the virtual machine based on the target snapshot data in the block device.

12. The electronic device of claim 10, wherein the computer-executable instructions further cause the processor to:
acquire traffic data and delay data of the block device; and
determine a target number of the snapshot copies according to the traffic data and the delay data of the block device; and
the computer-executable instructions for sending the snapshot download request to the image center comprise a computer-executable instruction which, when executed by the processor, causes the processor to:
send a first snapshot download request to the image center to download the target number of snapshot copies from the image center.

13. The electronic device of claim 12, wherein the computer-executable instructions further cause the processor to:
acquire a number of block devices located in the elastic block storage; and
determine the target number of the snapshot copies according to the number of block devices, the traffic data of each block device and the delay data of each block device.

14. The electronic device of claim 13, wherein the computer-executable instructions further cause the processor to:
determine a delay proportion according to the delay data of each block device and a block device delay threshold;
obtain an average traffic of a single block device according to the delay proportion and a current traffic-limiting value of each block device;
obtain a connection number of block devices to which a single snapshot copy is able to connect according to a ratio of traffic provided by the single snapshot copy to the average traffic; and
obtain the target number according to the number of block devices and the connection number of block devices to which the single snapshot copy is able to connect.

15. The electronic device of claim 10, wherein the computer-executable instructions further cause the processor to:
send an image data read request to a distributed file storage system through the block device; and
acquire, through the file storage system, the log file corresponding to the snapshot copy, and send the log file to the corresponding block device.

16. The electronic device of claim 10, wherein the computer-executable instructions further cause the processor to:
acquire traffic data and delay data of the block device; and
set a traffic upper limit of the block device according to the traffic data and the delay data of the block device.

17. The electronic device of claim 16, wherein the computer-executable instructions further cause the processor to:
acquire a current traffic upper limit of each block device; and
determine a target block device according to a magnitude relationship between the traffic data of the block device and a preset traffic-limiting value and a magnitude relationship between the delay data of the block device and a delay threshold, and set the current traffic upper limit of the target block device.

18. The electronic device of claim 17, wherein the computer-executable instructions further cause the processor to:
acquire a service basic coefficient, wherein the service basic coefficient is used to characterize a service level corresponding to the virtual machine; and
obtain the delay threshold according to the service basic coefficient and an average delay of each block device.

19. A non-transitory computer-readable storage medium, wherein computer-executable instructions are stored in the computer-readable storage medium, and the computer-executable instructions, when executed by a processor, cause the processor to:
receive a lazy load request sent by a virtual machine to a block device of elastic block storage, acquire target snapshot data, and send a snapshot download request to an image center to download at least two snapshot copies, wherein the block device is used to store a data resource required for starting the virtual machine, a snapshot copy is image data of the data resource required for starting the virtual machine, and the target snapshot data is a data resource required for running a target function of the virtual machine;
connect each block device to a corresponding snapshot copy to obtain log files corresponding to the at least two snapshot copies respectively; and
form a cloned block device by loading, through the block device, a log file corresponding to the snapshot copy, and start the virtual machine based on the cloned block device.

20. The non-transitory computer-readable storage medium of claim 19, wherein the computer-executable instructions further cause the processor to:
send an image data read request to a distributed file storage system through the block device; and
acquire, through the file storage system, the log file corresponding to the snapshot copy, and send the log file to the corresponding block device.
